(19) United States
(12) Patent Application Publication
(10) Pub. No.: US 2026/0005881 A1
(43) Pub. Date: Jan. 1, 2026

(54) AUTHENTICATION OF BLOCKCHAIN ADDRESSES, USING CROSS-CHAIN COMMUNICATION

(71) Applicant: Ava Labs, Inc., New York, NY (US)

(72) Inventor: Daniel Louis Laine, Jersey City, NJ (US)

(21) Appl. No.: 19/245,636

(22) Filed: Jun. 23, 2025

Related U.S. Application Data
(60) Provisional application No. 63/665,554, filed on Jun. 28, 2024.

(51) Int. Cl. H04L 9/00; G06F 16/24; H04L 9/40

(52) U.S. Cl. CPC H04L 9/50; G06F 16/24; H04L 63/08

(57) ABSTRACT

In some implementations, a method for performing authentication of blockchain addresses is provided, using cross-chain communication techniques. Ownership of a blockchain address is verified, along with off-chain attributes of the blockchain address owner. An identification service blockchain of an identification service stores a relational link between the blockchain address and the off-chain attributes of the owner of the blockchain address. The identification service receives from a transaction blockchain using a cross-chain protocol, an attribute query for attribute data corresponding to at least some of the off-chain attributes. In response to receiving the attribute query, the attribute data is retrieved from the identification service blockchain, and is provided as an attribute response to the transaction blockchain that includes the blockchain address.

### CROSS-REFERENCE TO RELATED APPLICATIONS

This application claims the priority benefit of U.S. Provisional Patent Application No. 63/665,554, filed June 28, 2024, the entirety of which is incorporated herein by reference.

### TECHNICAL FIELD

This specification generally relates to performing authentication of blockchain addresses, using cross-chain communication techniques.

### BACKGROUND

A blockchain is a distributed ledger to which blocks of records are added over time. The blocks can be securely linked together through cryptographic hashes, with each block including a cryptographic hash of the previous block, a timestamp, and transaction data. Thus, blockchain transactions are generally irreversible in that the data in a given block cannot be altered once it is added to the blockchain, without also altering subsequent blocks.

In general, blockchain technology can be used to provide data accessibility, while ensuring privacy and security. Data can be securely transmitted and stored, using end-to-end encryption. Further, data can be openly authenticated, such that the data is trusted as being reliable. Thus, sensitive data can be handled in a way that maintains user privacy.

### SUMMARY

This document generally describes computer systems, processes, program products, and devices for performing authentication of blockchain addresses, using cross-chain communication techniques. In general, an identification service (e.g., a trusted entity that can perform as an information oracle) can attest to the real-world attributes of an owner of a blockchain address, and can maintain the real-world attributes on an identification service blockchain. The identification service can then be queried by other blockchains (e.g., transaction blockchains) for information pertaining to the real-world attributes (e.g., when determining whether a blockchain transaction involving the blockchain address should be processed), and corresponding responses can be provided.

The identification service can confirm ownership of a blockchain address by an individual, and can verify the real-world identity and attributes of the individual. To verify the individual's real-world identity and attributes, a form of identification can be presented to the identification service. To verify ownership of the blockchain address, the individual can perform an action that cryptographically proves ownership of the private key corresponding to the blockchain address (e.g., by cryptographically signing a message). Once ownership of the blockchain address has been established, and the blockchain address owner's real-world identity and attributes have been verified, a relational link between the blockchain address and the owner's real-world attributes can be generated and stored by an identification service blockchain.

When a transaction blockchain receives an attribute-restricted transaction(e.g., a transaction for which a decision of whether the transaction is to be committed or rejected depends at least in part on an address owner's attributes), the transaction can employ a cross-chain communication protocol of the identification service to query the attribute service blockchain for data that indicates whether the address owner possesses specified attributes. In response to receiving the attribute query, attribute data can be retrieved from the identification service blockchain, and an attribute response including the retrieved attribute data can be provided to the transaction blockchain (e.g., using the cross-chain communication protocol). The transaction blockchain can then determine whether to commit or reject the transaction, based on the blockchain address owner's attribute data included in the attribute response. Optionally, the identification service can log data that represents the attribute query/response, for possible reporting purposes.

In some implementations, a method for performing authentication ofblockchain addresses includes storing, by an identification service blockchain of an identification service, a relational link between a blockchain address and a plurality of off-chain attributes that pertain to an owner of the blockchain address; receiving, by the identification service and from a transaction blockchain that includes the blockchain address, an attribute query for attribute data corresponding to at least some of the plurality of off-chain attributes that pertain to the owner of the blockchain address; in response to receiving the attribute query, retrieving, from the identification service blockchain, the attribute data corresponding to at least some of the plurality of off-chain attributes; and providing, by the identification service and to the transaction blockchain that includes the blockchain address, an attribute response that includes the attribute data corresponding to at least some of the plurality of off-chain attributes.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. An off-chain identity of the owner of the blockchain address can be verified, the plurality of off-chain attributes that pertain to the owner of the blockchain address can be verified, and a verification of whether the owner of the blockchain address owns the blockchain address can be performed. Verifying the off-chain identity of the owner of the blockchain address and verifying the plurality of off-chain attributes that pertain to the owner of the blockchain address can be based on a presentation of a form of identification by the owner of the blockchain address to the identification service. Verifying that the owner of the blockchain address owns the blockchain address can include receiving a message that has been signed using a private key that is under the control of the owner of the blockchain address, and determining that the private key corresponds to the blockchain address by decrypting the signed message with a public key of the blockchain address. Verifying that the owner of the blockchain address owns the blockchain address can include witnessing that a transaction has been signed by the owner of the blockchain address using a private key that corresponds to the blockchain address, and witnessing that the transaction blockchain that includes the blockchain address has confirmed the transaction. The transaction can be signed using a cryptocurrency wallet of the owner of the blockchain address. Witnessing that the transaction blockchain that includes the blockchain address has confirmed the transaction can include monitoring a blockchain explorer of the transaction blockchain. Receiving the attribute query and providing the attribute response can be performed using a cross-chain messaging protocol of the identification service. The cross-chain messaging protocol can include providing, to the transaction blockchain, a public key of the identification service, and signing, by one or more nodes of the identification service blockchain, the attribute response, such that the transaction blockchain is enabled to cryptographically prove that the attribute response is from the identification service using the public key of the identification service. The identification service can publish a set of enumerated attributes that are available for querying. The attribute query received from the transaction blockchain can include a request for confirmation of whether an attribute value of the owner of the blockchain address corresponds to an enumerated attribute value represented in the attribute query. The attribute response can be a binary value that indicates whether the attribute value of the owner of the blockchain address corresponds to the enumerated attribute value represented in the attribute query. The identification service can log data that represents a received attribute query and a corresponding attribute response. The identification service can receive, from a requestor device, a request for attribute query/response log data. In response to receiving the request for attribute query/response log data, query/response log data that corresponds to the request can be retrieved from the identification service blockchain, and the retrieved query/response log data can be provided to the requestor device. The identification service can receive a report of a compromised private key that corresponds to the blockchain address. An off-chain identity of the owner of the blockchain address can be verified. An update to the identification service blockchain can be submitted that removes the relational link between the blockchain address and the plurality of off-chain attributes that pertain to the owner of the blockchain address.

The systems, devices, program products, and processes described throughout this document can, in some instances, provide one or more of the following advantages. A cross-chain messaging protocol can include the use of cryptographic techniques, such that a transaction blockchain network can cryptographically prove that a response from an identification service is actually from the service. By using the cross-chain messaging protocol to query the identification service for real-world off- chain information that pertains to blockchain addresses involved in a particular transaction, the transaction blockchain network can appropriately restrict particular transactions without having to collect and maintain personal data of its address owners. Thus, a user of the transaction blockchain does not need to provide potentially sensitive personal information to the blockchain network, thereby improving privacy and security. Further, multiple different transaction blockchain networks can use the same identification service, thereby reducing implementation complexity for transaction blockchain developers, and reducing the amount of data stored on each transaction blockchain. The identification service can return an attribute response that specifies whether the address owner is associated with an aggregated/generalized attribute rather than a discrete attribute, thus further securing the privacy of the address owner's personal information.

Other features, aspects and potential advantages will be apparent from the accompanying description and figures.

### DESCRIPTION OF DRAWINGS

FIG. 1 is a conceptual diagram of an example system for authenticating blockchain addresses using cross-chain communication techniques.

FIGS. 2A-2D depict an example illustrative system and process for authenticating blockchain addresses using cross-chain communication techniques.

FIG. 3 is a schematic diagram that shows an example of a computing system.

Like reference symbols in the various drawings indicate like elements.

### DETAILED DESCRIPTION

This document describes technology that can facilitate the performance of user authentication for blockchain transactions using cross-chain communication techniques. In general, an identification service (e.g., a trusted entity that can perform as an information oracle) can attest to the real-world attributes of an owner of a blockchain address, and can maintain the real-world attributes on an identification service blockchain. The identification service can then be queried by other blockchains (e.g., transaction blockchains) for information pertaining to the real-world attributes (e.g., when determining whether a blockchain transaction involving the blockchain address should be processed), and corresponding responses can be provided.

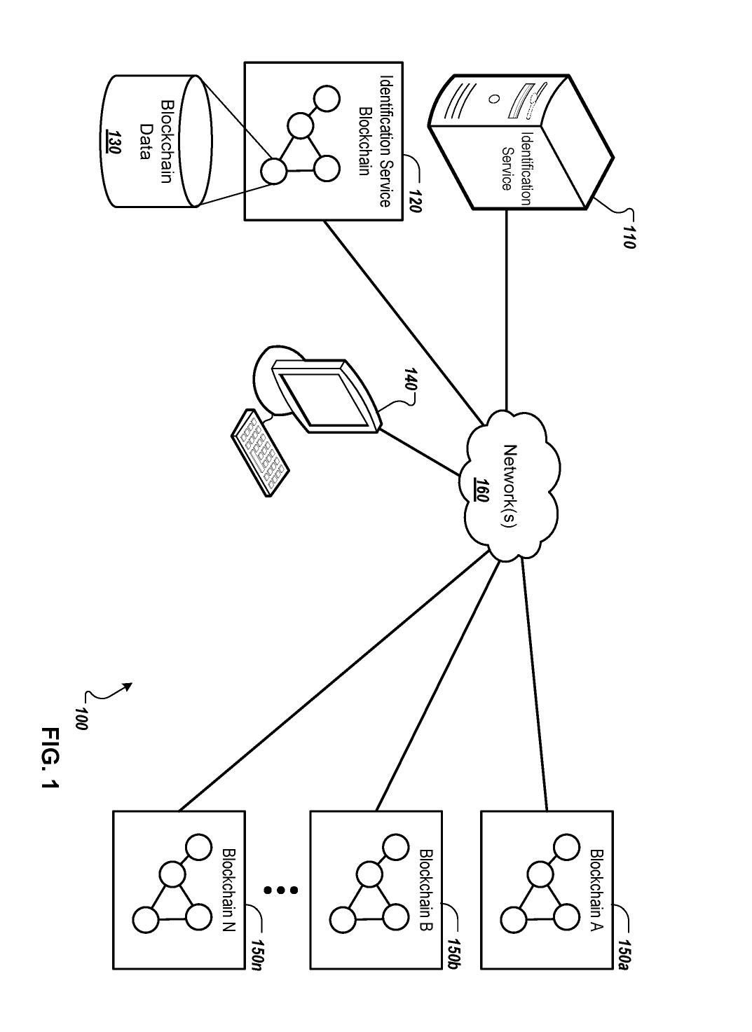

FIG. 1 is a conceptual diagram of an example system 100 for authenticating blockchain addresses using cross-chain communication techniques. In general, the system 100 can include various computing devices, server systems, blockchain networks, and data stores, configured to communicate with each other over one or more communication networks. For example, the system 100 can include an identification service 110, an identification service blockchain 120, blockchain data stores 130, various client devices 140, and various transaction blockchains 150a-n, that can communicate and exchange data over networks(s) 160 (e.g., including one or more LANs (local area networks), WANs (wide area networks), and/or the Internet).

The identification service 110, for example, represents a computer-based service that can be provided by various forms of computing servers, including but not limited to network servers, web servers, application servers, or other suitable computing servers. For example, the identification service 110 can be provided by one or more computing servers that communicate over the network(s) 160 with computing nodes of the identification service blockchain 120. As another example, the identification service 110 can represent a node of the identification service blockchain 120 itself, with the nodes of the identification service blockchain 120 collectively performing operations of the identification service 110.

The identification service 110 can be configured to provide a cross-chain messaging protocol that facilitates the exchange of information between the identification service blockchain 120 and the various transaction blockchains 150a-n. The cross-chain messaging protocol, for example, can be implemented using blockchain bridges, relays, sidechains, chain federations, merged consensus connections, or other suitable cross-chain technologies. In the present example, the identification service 110 can operate as a front end to an information oracle that receives off-chain, real-world information, stores the information on the identification service blockchain 120, and provides the stored information in response to requests from various computing devices (e.g., including nodes of the various transaction blockchains 150a-n and/or the various client devices 140). Conceptually, the cross-chain messaging protocol can function as an application programming interface (API) (or another sort of request/response interface). Computing devices that interact with the identification service 110, for example, can be provided with definitions of possible requests that can be submitted to the service 110, and definitions of possible responses that can be returned by the service 110.

In some implementations, the cross-chain messaging protocol can include the use of cryptographic techniques. For example, the cross-chain messaging protocol of the identification service 110 can include the signing of messages (e.g., data encoded in an array of bytes) by one or more nodes the identification service blockchain 120 (e.g., using a Boneh-Lynn-Schacham (BLS) signature scheme, or another suitable signature scheme). Optionally, signature aggregation can be performed to aggregate the signatures of different signers (e.g., multiple different validator nodes of the identification service blockchain 120) into a shortened multi-signature, which can subsequently be verified by a message recipient. The signed message can be transmitted to a message destination (e.g., one of the transaction blockchains 150a-n), for example. In the present example, upon receiving the signed message, one or more nodes of the transaction blockchain can verify the signed message. The one or more nodes of the transaction blockchain can reference the public key (e.g., a BLS public key) of the identification service blockchain 120, for example, and can verify the authenticity of the message using the public key and the signature. Thus, the transaction blockchain can cryptographically prove that a response from the identification service 110 is actually from the service.

The identification service blockchain 120, for example, can be a blockchain network including a plurality of computing nodes that are configured to communicate with and exchange data with each other (e.g., over the network(s) 160), with at least some of the computing nodes being validator nodes that are configured to maintain the blockchain 120 (e.g., through a consensus protocol). The computing nodes of the identification service blockchain 120, for example, can each be various forms of servers, including but not limited to network servers, web servers, application servers, or other suitable computing servers. Each of the computing nodes can include one or more processors, memory devices, and storage devices. In some implementations, the computing nodes can be configured as a peer-to-peer network, in which nodes can be flexibly added to or removed from the network over time. Each of the computing nodes in the peer-to-peer blockchain network, for example, can directly communicate with other network nodes, and can participate in network functions, such as executing code (e.g., blockchain application software, smart contracts, etc.), broadcasting and validating blockchain transactions, generating new blocks of transactions, verifying generated blocks, and so forth.

The blockchain data 130 represents persistent data that is maintained by the identification service blockchain 120. In general, the blockchain data 130 can include a series of consecutively added and linked blocks, with each block including one or more transactions that occurred in the blockchain 120 over consecutive time windows of substantially similar durations (e.g., a fraction of a second, several seconds, or several minutes, depending on the type and configuration of the blockchain 120). In some implementations, multiple of the computing nodes of the identification service blockchain 120 can maintain a separate copy (e.g., a full or partial copy) of the blockchain (e.g., using one or more databases, file systems, and/or cached data sources). Thus, decentralization, robustness, and persistence of the identification service blockchain 120 can be ensured.

The client computing device(s) 140, for example, can represent various forms of stationary or mobile computing devices including, but not limited to a desktop computer, a laptop computer, a tablet computer, a personal digital assistant (PDA), a smartphone, or other processing devices. In general, the client computing device 140 can be used to communicate with (e.g., over the network(s) 160) the identification service 110 / identification service blockchain 120, and/or nodes of any of the transaction blockchains 150a-n. The client computing device 140, for example, can include various input devices (e.g., keyboard, mouse, pointer, touchscreen, microphone, etc.) for receiving input from a device operator, and various output devices (e.g., display, printer, speaker, etc.) for presenting output to the device operator.

Similar to the identification service blockchain 120, for example, each of the transaction blockchains 150a-n can be a blockchain network including a plurality of computing nodes that are configured to communicate with and exchange data with each other (e.g., over the network(s) 160). Further, the respective computing nodes of the respective transaction blockchains 150a-n, for example, can each be various forms of servers, including but not limited to network servers, web servers, application servers, or other suitable computing servers, and can each include one or more processors, memory devices, and storage devices. Blockchain network functions and protocols can vary between each of the transaction blockchains 150a-n, for example.

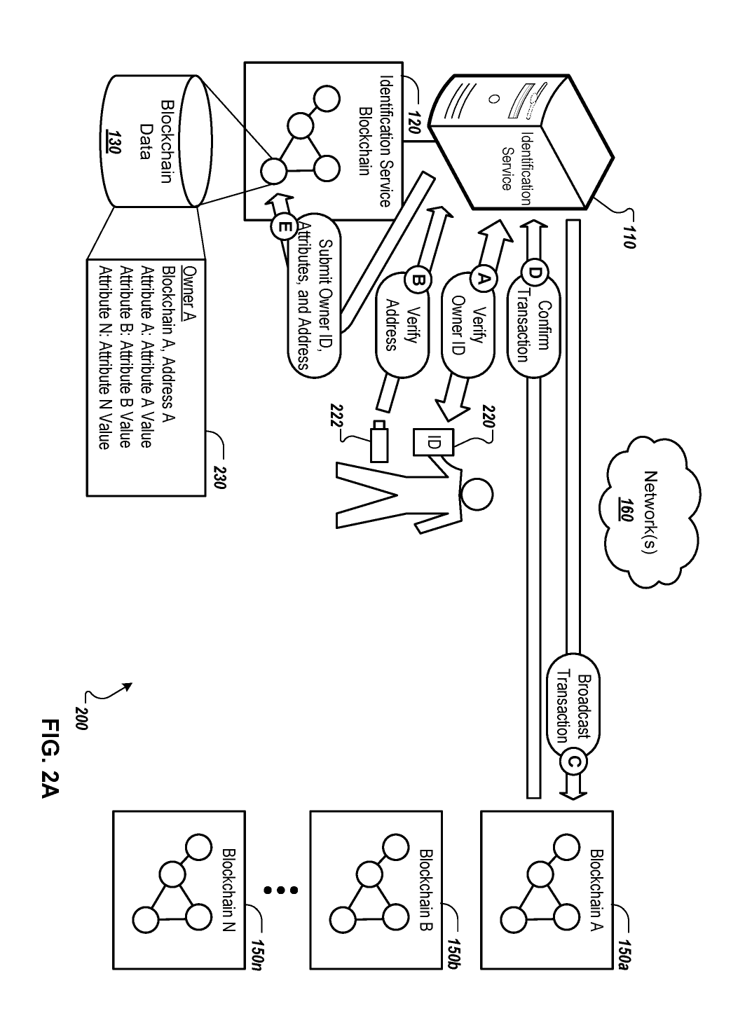

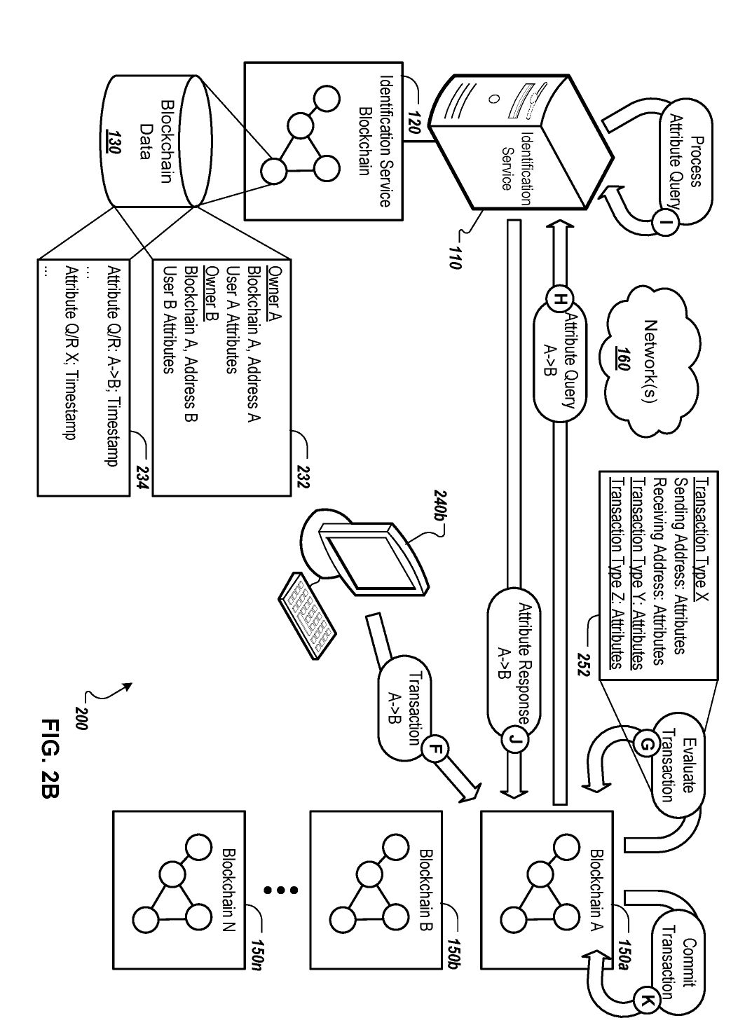

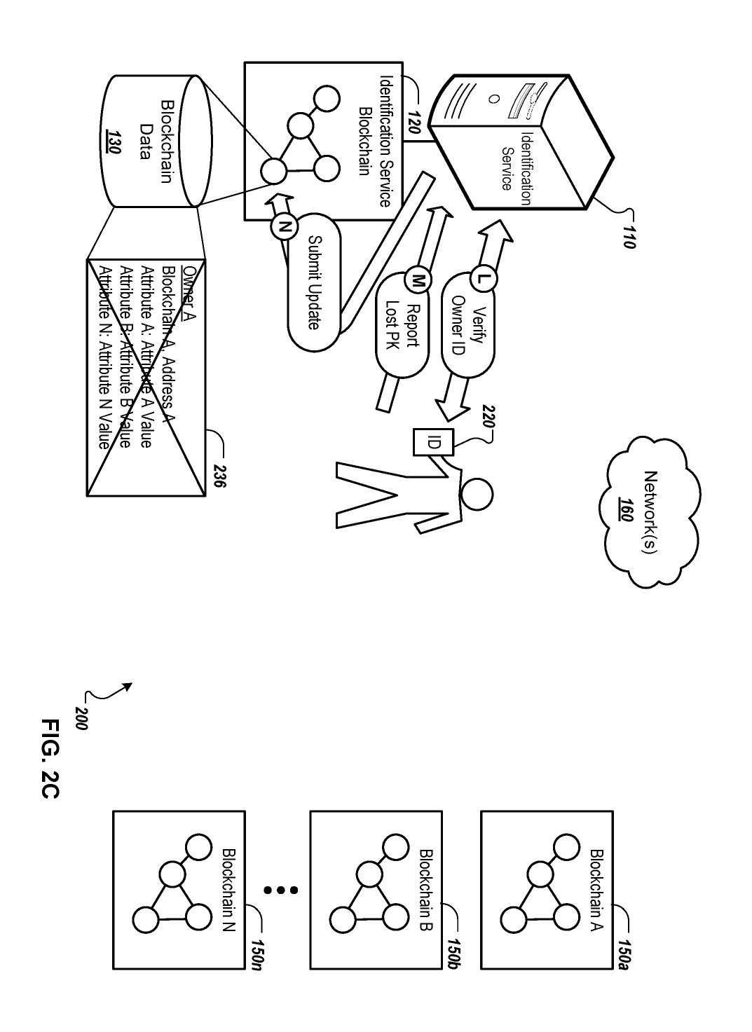

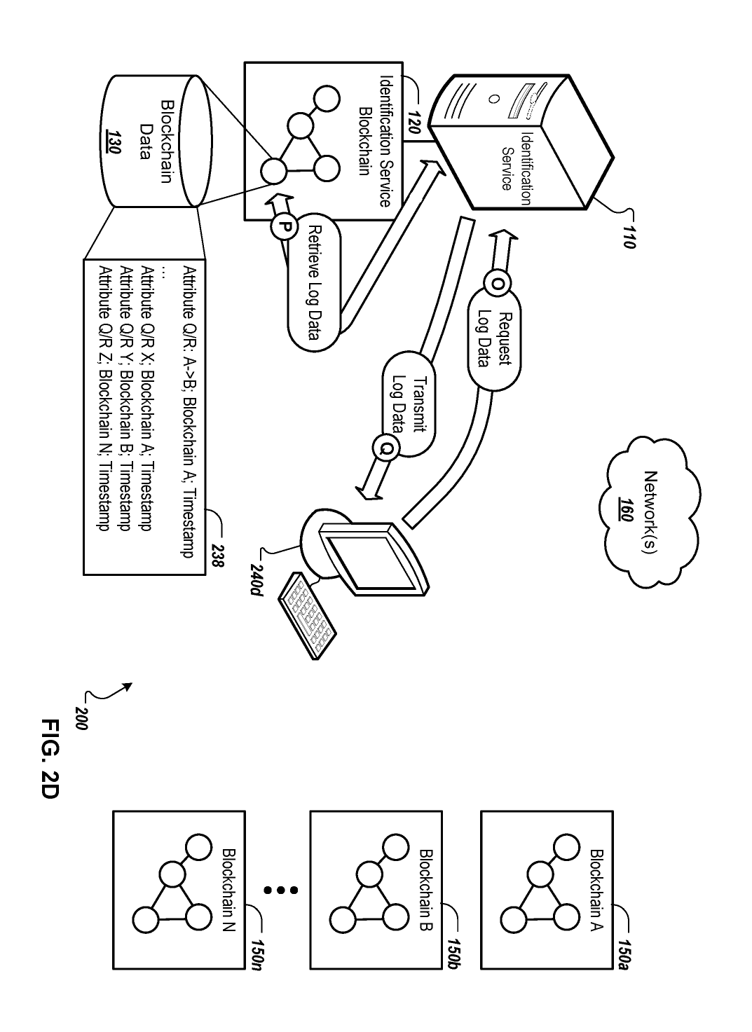

Referring now to FIGS. 2A-2D, an example illustrative system 200 and process are shown for authenticating blockchain addresses using cross-chain communication techniques, as represented in example stages (A) to (Q). Stages (A) to (Q) may occur in the illustrated sequence, or they may occur in a sequence that is different than in the illustrated sequence, and/or two or more stages (A) to (Q) may be concurrent. In some examples, one or more stages (A) to (Q) may be repeated multiple times when authenticating blockchain transactions.

Referring to FIG. 2A, operations are shown for attesting the real-world personal attributes (traits, characteristics, etc.) of an owner of a blockchain address, and for generating and maintaining a link between the real-world attributes and the blockchain address. In general, the operations can be facilitated by a trusted entity (e.g., a Know Your Customer (KYC) service provider or another trusted entity) that is authorized to collect and securely maintain the private data of individuals. In some examples, the operations shown in FIG. 2A can be initiated at a physical location where the owner of the blockchain address is in the presence of a worker (e.g., human, robotic, automated device, etc.) that is associated with the trusted entity. In some examples, the operations shown in FIG. 2A can be initiated in an online environment where the owner of the blockchain address is remote from the worker that is associated with the trusted entity. In some examples, the operations shown in FIG. 2A can be performed using camera devices, biometric data collection equipment, or other devices for verifying the identity of individuals.

During stage (A), an owner of a blockchain address is identified and their personal attributes are verified. For example, the owner of the blockchain address can present one or more forms of identification (e.g., identification document 220, which can represent an identification card, a driver's license, a passport, or another sort of physical or electronic identification document) to the worker that is associated with the trusted entity (e.g., either in the physical presence of the worker, or using remote telecommunications devices), and the worker can verify whether the owner is represented by the form of identification. In general, a form of identification can list various attributes of an individual. For example, an identification document can include a unique identifier that is associated with the individual, a photo of the individual, various physical attributes of the individual, a date of birth of the individual, a residential address of the individual, a citizenship of the individual, various credentials of the individual (e.g., authorization to operate a vehicle, authorization to perform a particular service/occupation, membership in an organization, ownership of an asset, etc.), and/or other attributes. Once the owner of the blockchain address has been identified and their attributes have been verified (e.g., by performing a comparison of the owner to the photo and/or the physical attributes included in the identification document 220 or other form of identification, through the analysis of data collected from one or more identification verification devices, etc.), at least a portion of the attributes of the owner can be collected and persisted in memory of the identification service 110.

In some implementations, identifying an owner of a blockchain address and verifying their attributes can include referencing one or more online data sources. For example, a unique identifier of the owner (e.g., an identifier included on the identification document 220 or otherwise provided by the owner) can be submitted by the identification service 110 to an online data source (not shown) that maintains data that corresponds to attributes of the owner. In response, the online data source can return data corresponding to the owner's attributes (which may or may not be represented on the one or more forms of identification). The returned owner attribute data, for example, can be used to identify the owner and/or can be collected and persisted in memory of the identification service 110.

During stage (B), operations for verifying ownership of the blockchain address can be initiated. For example, the same individual that has been identified and whose attributes are verified by the identification service 110 can also submit proof of ownership of the blockchain address to the identification service 110. In general, the operations for verifying ownership of the blockchain address can involve the performance of an action that cryptographically proves ownership of the private key corresponding to the blockchain address (e.g., by cryptographically signing a message).

In some implementations, ownership of the blockchain address can be verified by receiving a message that has been signed using a private key that is under the control of the owner of the blockchain address, and determining that the private key corresponds to the blockchain address. For example, the identification service 110 can receive a message that is signed by an individual who professes to be the owner of the blockchain address, and the service can determine that the private key corresponds to the blockchain address by decrypting the signed message with a public key of the blockchain address. The identification service 110, for example, can obtain the public key of the blockchain address from the address owner, and can verify whether the public key corresponds to the blockchain address through the signed message. If so, the identification service 110 can determine that the professed owner of the blockchain address is the actual address owner.

In some implementations, ownership of the blockchain address can be verified through the signing, broadcasting, and confirmation of a blockchain transaction from the blockchain address of the owner. For example, a professed owner of the blockchain address can submit a transaction to a transaction blockchain (e.g., one of the transaction blockchains 150a-n) while being witnessed by a worker of the identification service 110, and the service 110 can observe whether the transaction is broadcast and committed. If so, the identification service 110 can determine that the professed owner of the blockchain address is the actual address owner.

In some implementations, messages and/or transactions can be signed using a cryptocurrency wallet. For example, the owner of the blockchain address can provide data from a physical cryptocurrency wallet (e.g., a hardware wallet that includes a data storage device), including a private key that corresponds a blockchain address for a transaction blockchain (e.g., one of the transaction blockchains 150a-n) to sign a message and/or to submit a transaction. As another example, the owner of the blockchain address can provide data from a software cryptocurrency wallet (e.g., a software application executed by the owner's client device), including a private key that corresponds to a blockchain address for a transaction blockchain, to sign a message and/or to submit a transaction. As another example, the owner of the blockchain address can provide a visual representation of a private key that corresponds to a blockchain address for a transaction blockchain (e.g., as a string value, as a quick response (QR) code, or another sort of visual representation) to sign a message and/or to submit a transaction.

During stages (C) and (D), a broadcast of a blockchain transaction and a confirmation of the transaction is optionally witnessed. For example, the identification service 110 can witness the blockchain transaction being signed by the owner of the blockchain address (e.g., using a private key from the owner's cryptocurrency wallet), can witness the transaction being broadcast to a transaction blockchain (here, blockchain 150a, or "Blockchain A"), and can witness confirmation of the transaction. Thus, in the present example, the identification service 110 can verify whether an individual who professes to be the owner of a particular blockchain address of a particular blockchain is the actual owner.

In some implementations, witnessing a broadcast of a transaction and a confirmation of the transaction can be performed by accessing a blockchain explorer. For example, the identification service 110 can provide a recipient address on the transaction blockchain 150a to the owner of the blockchain address, and the owner of the blockchain address can sign a transaction that involves a blockchain transaction (e.g., a transfer of a nominal amount of cryptocurrency, or another sort of verifiable transaction) from the owner's address to the provided recipient address, and the identification service can monitor the blockchain explorer for broadcast and confirmation of the transaction involving the blockchain address and the recipient address. In some examples, the transaction signing can be performed using a personal client device of the owner of the blockchain address. In some examples, the transaction signing can be performed using a front-end device (not shown) of the identification service 110.

During stage (E), the blockchain address owner's identification and verified attributes are submitted to an identification service blockchain for storage. For example, after the blockchain address owner has been identified, their attributes have been verified, and their ownership of the blockchain address has been verified, the identification service 110 can submit data that represents the blockchain address owner and one or more attributes of the blockchain address owner (e.g., from persisted memory), and can submit data that represents the blockchain address and the blockchain that includes the address, for storage on the identification service blockchain 120. In the present example, "Owner A" is associated with "Address A" on "Blockchain A," and is associated with "Attribute A," "Attribute B," and "Attribute N," with each attribute having a respective value that pertains to the blockchain address owner. After receiving blockchain address data and owner attribute data 230 (e.g., data that represents the blockchain address owner, the one or more attributes, the blockchain address, and the blockchain), for example, the identification service blockchain 120 can store the data 230 with the blockchain data 130. Thus, in the present example, a relational link has been generated and stored between the blockchain address owner's on-chain identity (e.g., the blockchain address), and their real-world identity (e.g., including their various attributes).

In some instances, an individual may be associated with multiple blockchain addresses, possibly from multiple different blockchains. For example, the individual who owns "Address A" on the blockchain 150a ("Blockchain A") can own one or more other addresses on "Blockchain A," and/or can own one or more other addresses on the blockchain 150b ("Blockchain B") and/or the blockchain 150n ("Blockchain N"). For such instances in which the individual is associated with multiple blockchain addresses, for example, stages (B), (C), (D), and (E) can be repeated for each blockchain address that is to be associated with the individual and the individual's attributes.

In some instances, an individual's attributes can be updated at a later time. For example, one or more the individual's attributes can change over time (e.g., address, citizenship, credentials, etc.), and the blockchain data 130 can be updated to reflect the changes to the individual's attributes. To update the individual's attributes, for example, the individual can at a later time provide an updated form of identification to the identification service 110, the individual's identity can again be verified and the individual's updated attributes can be confirmed (e.g., during a repeat of stage (A)), and updated data can be provided to the identification service blockchain 120 for storage as blockchain data 130. As another example, identification service 110 can receive updated information that pertains to the individual from one or more online data sources (not shown), and can provide updated data to the identification service blockchain 120 for storage as blockchain data 130. As the verification of blockchain address ownership and the verification of real-world identity/attributes involve separate operations, for example, it may be possible for the identification service 110 to update data that pertains to an individual's attributes without again verifying ownership of blockchain addresses.

Referring to FIG. 2B, operations are shown for processing a blockchaintransaction that depends on the real-world attributes of the owners of one or more blockchain addresses involved in the transaction. In general, many blockchains may not maintain data that pertains to the real-world attributes of their users. However, for some types of transactions (e.g., transactions that involve the transfer of tokens from one address to another address, transactions that involve the provision of particular types of data, etc.) and/or according to certain circumstances (e.g., regulations that may pertain to individuals having particular attributes, such as age-based regulations, residence-based regulations, citizenship-based regulations, etc.), the real-world user attributes may be applicable as to whether a transaction should be executed or not. By using a cross-chain messaging protocol to query the identification service 110 for real-world off-chain information that pertains to the blockchain addresses involved in a particular transaction, for example, a blockchain network (e.g., nodes of any of the transaction blockchains 150a-n) can be provided with the capability to appropriately restrict particular transactions without having to maintain personal data of its address owners (thus ensuring user privacy within a transaction blockchain).

During stage (F), a transaction is submitted by a client device to a transaction blockchain. For example, an individual can employ client computing device 240b (e.g., similar to the client computing device 140, shown in FIG. 1) to cryptographically sign and submit the transaction to a blockchain network that supports the transaction blockchain 150a ("Blockchain A"). In the present example, the individual that employs the client computing device 240b can be the address owner of "Address A" on "Blockchain A," and the transaction can be a transaction that transfers a specified number of tokens from "Address A" to "Address B" (also on "Blockchain A"). As another example, the transaction can be a transaction that transfers data (e.g., tokens, or another sort of data) from a first blockchain to a second blockchain (e.g., from "Blockchain A" to either of "Blockchain B" or "Blockchain N"). As another example, the transaction can be a transaction that involves a single blockchain address (e.g., a request for blockchain data, a request for a blockchain network to perform a specified operation, etc.).

During stage (G), the transaction blockchain evaluates the transaction. For example, one or more nodes of the transaction blockchain 150a ("Blockchain A") can evaluate the transaction that was cryptographically signed and submitted by the client computing device 240b, by verifying the signature (ensuring that the transaction was submitted by an address owner with access to a private key that corresponds to a sending/requesting address), and by identifying a transaction type that corresponds to the submitted transaction (e.g., a request to transfer tokens from a sending blockchain address to a receiving blockchain address, a request for another sort of data to be transmitted to a requesting address, a request for a blockchain network to perform a specified operation, etc.). Once the transaction type of the submitted transaction has been identified, for example, the one or more nodes of the transaction blockchain 150a can reference the transaction type within a transaction type data structure 252 (e.g., a data structure maintained by the transaction blockchain 150a) that maps various transaction types to specified real-world off-chain attributes that are to be associated with a sending address and/or receiving address (and/or requesting address) that is involved in the transaction. In the present example, the submitted transaction involves a transfer of tokens from a sending address (e.g., "Address A") to a receiving address (e.g., "Address B"), and is thus identified in the transaction type data structure 252 as being an attribute-restricted transaction (e.g., "Transaction Type X"). For each of the sending address and the receiving address in the present example, the transaction data structure 252 includes a specification of one or more real-world off-chain attributes that are to be associated with the corresponding address owners (with the specification of attributes associated with the sending address possibly being different from the specification of attributes associated with the receiving address), in order for the transaction to be committed.

During stage (H), the transaction blockchain transmits data that represents an attribute query to an identification service. For example, a node of the transaction blockchain 150a ("Blockchain A") can use the cross-chain messaging protocol of the identification service 110 to transmit an attribute query that requests confirmation of whether the address owners of the blockchain addresses involved in the submitted transaction possess the attributes that are specified for the type of transaction. The identification service 110, for example, can publish a set of enumerated attributes that are available for querying, and the attribute queries that are transmitted by nodes of the various transaction blockchains 150a-n can include a request for confirmation of whether the attribute values of the address owners correspond to attribute values represented in the attribute queries. In the present example, the attribute query transmitted by the node of "Blockchain A" includes a query of whether an owner of "Address A" is associated with attribute values that have been defined for a sending address, and whether an owner of "Address B" is associated with attribute values that have been defined for a receiving address, according to "Transaction Type X" in the transaction type data structure 252.

In some implementations a published set of enumerated attributes that are available for querying can refer to aggregated and/or generalized real-world, off-chain information. For example, the identification service 110 can provide a published enumerated attribute that indicates whether an address owner is a legal adult (which can vary based on the address owner's place of residence). Thus, when processing an attribute query, the identification service 110 can determine a current age of the address owner, can identify a current place of residence of the address owner, and can determine whether the current age of the address owner meets a threshold age of adulthood according to the address owner's current place of reference (e.g., by accessing a data structure that indexes legal ages of adulthoods against places of residence). In the present example, the identification service 110 can return an attribute response that specifies whether the address owner is associated with an aggregated/generalized attribute (e.g., being a legal adult), rather than one or more discrete attributes (e.g., a specific age or date of birth, a specific place of residence, etc.), thus maintaining the privacy of the address owner's identity as well as their discrete personal information.

During stage (I), the identification service processes the attribute query.For example, the identification service 110 can reference the blockchain data 130 maintained by the identification service blockchain 120 (or can instruct a blockchain network node to reference the blockchain data 130), to identify blockchain address and owner attribute data 232 that corresponds to the attribute query. In the present example, one or more "User A Attributes" of the owner of "Address A" (e.g., "User A"), and one or more "User B Attributes" of the owner of "Address B" (e.g., "User B") can be identified, with the identified attributes also being used to generate a response to the attribute query (e.g., including one or more discrete attribute values and/or one or more binary values that indicate whether a queried attribute value is present or not present).

In some implementations, generating a response to an attribute query caninclude generating a binary response. For example, if a particular attribute query is directed to whether a blockchain address owner possesses a particular attribute (e.g., residence (and/or citizenship) in a particular state/country, residence (and/or citizenship) in a defined set of states/countries, possession of a particular authorization/credential, ownership of a particular asset, etc.), the generated response can be a binary (e.g., yes/no) response to the query. As another example, if a particular attribute query is directed to whether a blockchain address owner is associated with an aggregated/generalized attribute (e.g., being a legal adult in the owner's place of residence), the response can generated by aggregating multiple owner attributes (e.g., based on predefined rules), and the generated response can be a binary (e.g., yes/no) response to the query.

During stage (J), the identification service transmits data that represents an attribute response to the transaction blockchain. For example, the identification service 110 can return (e.g., using cross-chain communication) the generated response to the transaction blockchain that transmitted the attribute query. In the present example, the identification service 110 (or another node of the identification service blockchain 120) can return to the blockchain 150a ("Blockchain A") an attribute response that indicates whether the owner of "Address A" possesses the real-world, off-chain attributes that have been specified for a sending address, and whether the owner of "Address B" possesses the real-world, off-chain attributes that have been specified for a receiving address, according to "Transaction Type X." As another example, for a transaction type that involves a single blockchain address (e.g., a requesting address), the attribute response can indicate whether the owner of the single blockchain address possesses the real-world, off-chain attributes that have been specified for that address.

In some implementations, data that corresponds to a received attributequery and a corresponding attribute response can be logged. For example, one or more nodes of the identification service blockchain 120 can generate and commit an attribute query/response log transaction that stores query/response log data 234 in the blockchain data 130 of the identification service blockchain 120. In the present example, the attribute query that was received from "Blockchain A" and the corresponding response that was returned to "Blockchain A" can be logged with a timestamp value. In general, logging may be performed when a historical record of actions of the identification service 110 is desired.

In some implementations, attribute queries can be received, processed, and responded to without logging. For example, the identification service 110 (including the nodes of the identification service blockchain 120) can receive the attribute query from "Blockchain A," and can process and respond to the query without logging any of the actions in the blockchain data 130. In general, logging may not be performed when a historical record of actions of the identification service 110 is not desired.

During stage (K), the transaction blockchain commits the transaction. For example, upon receipt of the attribute response, one or more nodes of the transaction blockchain 150a ("Blockchain A") can determine whether the owners of the blockchain addresses involved in the transaction have the real-world, off-chain attributes that have been specified for the transaction type, and if so, can commit the transaction to the transaction blockchain 150a. In the present example, the one or more blockchain nodes of "Blockchain A" can determine, based on the received attribute response, that the owner of "Address A" has the specified attributes for a sending address, and that the owner of "Address B" has the specified attributes for a receiving address, for "Transaction Type X," and can thus commit the transaction. If, however, one or more blockchain addresses involved in the transaction do not have the real-world, off-chain attributes that have been specified for the transaction type, the nodes of the transaction blockchain 150a ("Blockchain A") can discard and not commit the pending transaction.

Referring to FIG. 2C, operations are shown for reporting a lost (or compromised) private key of a blockchain address and for updating blockchain data to reflect the lost private key. In general, if a private key is lost/compromised, it may potentially be used by multiple different users for transactions that involve the corresponding blockchain address. Thus, the identification service 110 can update the blockchain data 130 to reflect the loss of the private key, by removing the link between a blockchain address and an address owner.

During stage (L), an owner of a blockchain address is identified. Similar to stage (A) (shown in FIG. 2A), for example, the owner of the blockchain address can present one or more forms of identification (e.g., identification document 220) to a worker that is associated with the identification service 110, and the worker can verify whether the owner is represented by the form of identification.

During stage (M), a lost private key is reported. For example, the owner of the blockchain address can report to the worker that is associated with the identification service 110 that the private key that corresponds to the blockchain address has been lost/compromised.

During stage (N), an update is submitted to an identification service blockchain. For example, the identification service 110 can submit an update to the identification service blockchain 120 indicating that any owner attributes that have previously been associated with the blockchain address in the blockchain data 130 are to be disassociated with the blockchain address. In the present example, one or more nodes of the identification service blockchain 120 can update blockchain address data and owner attribute data 236 that maintains the generated link between the blockchain address owner's on-chain identity (e.g., the blockchain address), and their real-world identity (e.g., including their various attributes), to indicate that the link is to be broken and that the blockchain address is not to be associated with any owner attributes. Thus, if a subsequent attribute query that pertains to the blockchain address were to be transmitted to the identification service 110, the corresponding attribute response would indicate that no owner attributes are associated with the blockchain address.

Referring to FIG. 2D, operations are shown for handling a request for attribute query/response log data. In general, providing an ability to request and receive attribute query/response log data can enable an entity (e.g., the identification service 110 and/or any of the transaction blockchains 150a-n) to prove that blockchain address owner attribute data was requested at a particular date/time, and to prove that a particular response was returned at the particular date/time. Such information may be useful for an auditing system, for example.

During stage (O), a client device transmits a request for attribute query/response log data to an identification service. For example, an individual (e.g., a worker of the identification service 110, a worker of any of the transaction blockchains 150a-n, or another individual) can employ client computing device 240d (e.g., similar to the client computing device 140, shown in FIG. 1) to submit a request to the identification service 110 for query/response log data that conforms to one or more request parameters (e.g., a specified date/time range, a specified blockchain, a specified blockchain address, etc.).

In some implementations, the request for attribute query/response log data can be restricted to a subset of attribute query/response log data for particular requestors. For example, the blockchain data 130 can include attribute query/response log data 238 that pertains to queries and responses for blockchain address owner attributes for addresses that exist on various different blockchains (e.g., any of blockchains 150a-n). The attribute query/response log data 238, for example, includes log entries for an attribute query/response with "Address A" being a sending address and "Address B" being a receiving address on "Blockchain A," with "Address X" being a requesting address on "Blockchain A," with "Address Y" being a requesting address on "Blockchain B," and with "Address Z" being a requesting address on "Blockchain N." In the present example, blockchain networks for each of the respective transaction blockchains 150a-n (e.g., "Blockchain A," "Blockchain B," and "Blockchain N") can be permitted to request attribute query/response log data 238 that pertains to queries/responses that occurred on the respective blockchains. As another example, other entities (e.g., the identification service 110) can be permitted to request any query/response log data 238.

During stage (P), attribute query/response log data is retrieved from the identification service blockchain, and during stage (Q), the retrieved attribute query/response log data is transmitted to the client device. For example, the identification service 110 can retrieve from the identification service blockchain 120 the attribute query/response log data 238 that confirms to the one or more request parameters provided in the request from the client computing device 240d, and can optionally restrict the retrieved data to a subset of attribute query/response log data (e.g., based on a source of the request). The client computing device 240d, for example, may have provided a credential along with the request for query/response log data that identifies the request as being authorized by one of the transaction blockchains 150a-n, and the identification service 110 can retrieve attribute query/response log data 238 that pertains only to that blockchain. In the present example, if attribute query/response log data is requested for queries/responses that occurred on "Blockchain A," the identification service can return log entries that pertain to "Blockchain A."

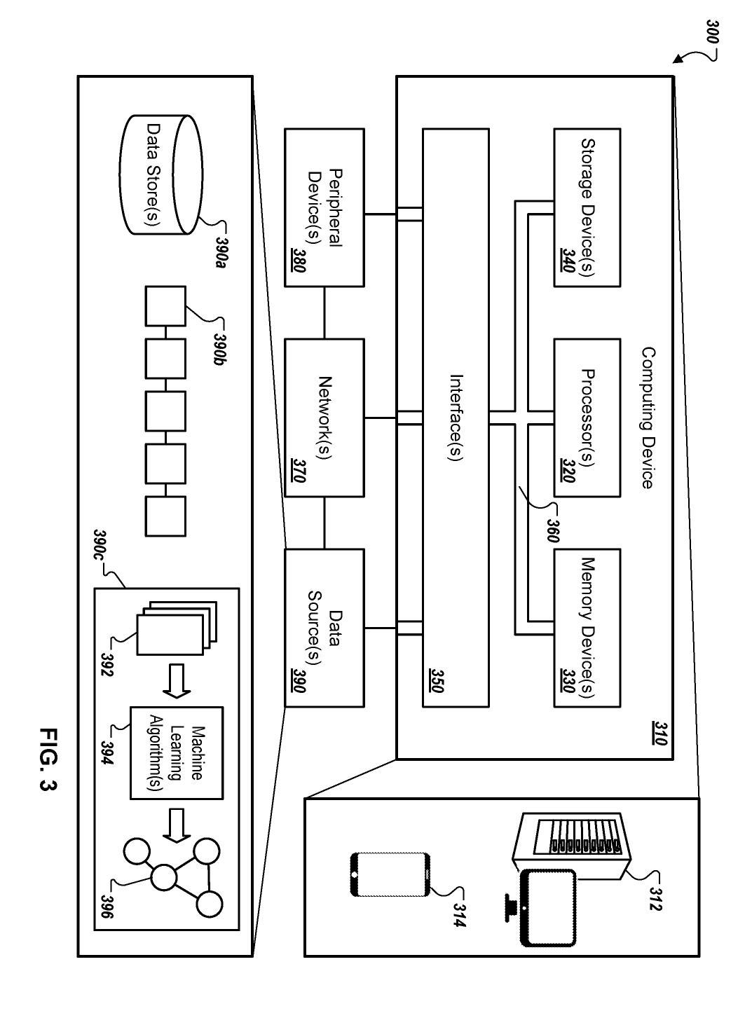

FIG. 3 is a schematic diagram that shows an example of a computing system 300 that can be used to implement the techniques described herein. The computing system 300 includes one or more computing devices (e.g., computing device 310), which can be in wired and/or wireless communication with various peripheral device(s) 380, data source(s) 390, and/or other computing devices (e.g., over network(s) 370). The computing device 310 can represent various forms of stationary computers 312 (e.g., workstations, kiosks, servers, mainframes, edge computing devices, quantum computers, etc.) and mobile computers 314 (e.g., laptops, tablets, mobile phones, personal digital assistants, wearable devices, etc.). In some implementations, the computing device 310 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 310, and an entire system can be made up of multiple devices communicating with each other. For example, the computing device 310 can be part of a computing system that includes a network of computing devices, such as a cloud-based computing system, a computing system in an internal network, or a computing system in another sort of shared network. Processors of the computing device (310) and other computing devices of a computing system can be optimized for different types of operations, secure computing tasks, etc. The components shown herein, and their functions, are meant to be examples, and are not meant to limit implementations of the technology described and/or claimed in this document.

The computing device 310 includes processor(s) 320, memory device(s)330, storage device(s) 340, and interface(s) 350. Each of the processor(s) 320, the memory device(s) 330, the storage device(s) 340, and the interface(s) 350 are interconnected using a system bus 360. The processor(s) 320 are capable of processing instructions for execution within the computing device 310, and can include one or more single-threaded and/or multi-threaded processors. The processor(s) 320 are capable of processing instructions stored in the memory device(s) 330 and/or on the storage device(s) 340. The memory device(s) 330 can store data within the computing device 310, and can include one or more computer-readable media, volatile memory units, and/or non-volatile memory units. The storage device(s) 340 can provide mass storage for the computing device 310, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 350 can include various communications interfaces (e.g., USB, Near-Field Communication (NFC), Bluetooth, WiFi, Ethernet, wireless Ethernet, etc.) that can be coupled to the network(s) 370, peripheral device(s) 380, and/or data source(s) 390 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location- related wireless data, which can be used as appropriate by device applications. The interface(s) 350 can include a control interface that receives commands from an input device (e.g., operated by a user) and converts the commands for submission to the processors 320. The interface(s) 350 can include a display interface that includes circuitry for driving a display to present visual information to a user. The interface(s) 350 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 370 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 310 can communicate with the peripheral device(s) 380, the data source(s) 390, and/or other computing devices over the network(s) 370. In some implementations, the computing device 310 can directly communicate with the peripheral device(s) 380, the data source(s), and/or other computing devices.

The peripheral device(s) 380 can provide input/output operations for the computing device 310. Input devices (e.g., keyboards, pointing devices, touchscreens, microphones, cameras, scanners, sensors, etc.) can provide input to the computing device 310 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 310 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 390 can provide data for use by the computing device 310, and/or can maintain data that has been generated by the computing device 310 and/or other devices (e.g., data collected from sensor devices, data aggregated from various different data repositories, etc.). In some implementations, one or more data sources can be hosted by the computing device 310 (e.g., using the storage device(s) 340). In some implementations, one or more data sources can be hosted by a different computing device. Data can be provided by the data source(s) 390 in response to a request for data from the computing device 310 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 390a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 390b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to- peer computer network, for example, the blockchain can maintain data quality (e.g., through data replication) and can improve data trust (e.g., by reducing or eliminating central data control).

In some implementations, a data source can include one or more machine learning systems 390c. The machine learning system(s) 390c, for example, can be used to analyze data from various sources (e.g., data provided by the computing device 310, data from the data store(s) 390a, data from the blockchain(s) 390b, and/or data from other data sources), to identify patterns in the data, and to draw inferences from the data patterns. In general, training data 392 can be provided to one or more machine learning algorithms 394, and the machine learning algorithm(s) can generate a machine learning model 396. Execution of the machine learning algorithm(s) can be performed by the computing device 310, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents attribute queries that have been received by an identification service, and attribute responses that have been provided by the identification service in response to the received attribute queries. The machine learning model that results from the machine learning algorithm(s) can be used to identify frequently provided attribute queries, to proactively cache responses to such queries, and to provide cached response data to computing devices that submit attribute queries. Use of the machine learning model can provide the benefit of faster response times to attribute queries.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include,by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other. While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer-implemented method for performing authentication of blockchain addresses, comprising:
storing, by an identification service blockchain of an identification service, a relational link between (i) a blockchain address and (ii) a plurality of off-chain attributes that pertain to an owner of the blockchain address;
receiving, by the identification service and from a transaction blockchain that includes the blockchain address, an attribute query for attribute data corresponding to at least some of the plurality of off-chain attributes that pertain to the owner of the blockchain address;
in response to receiving the attribute query, retrieving, from the identification service blockchain, the attribute data corresponding to at least some of the plurality of off-chain attributes; and
providing, by the identification service and to the transaction blockchain that includes the blockchain address, an attribute response that includes the attribute data corresponding to at least some of the plurality of off-chain attributes.

2. The computer-implemented method of claim 1, further comprising: verifying an off-chain identity of the owner of the blockchain address; verifying the plurality of off-chain attributes that pertain to the owner of the blockchain address; and verifying that the owner of the blockchain address owns the blockchain address.

3. The computer-implemented method of claim 2, wherein verifying the off-chain identity of the owner of the blockchain address and verifying the plurality of off-chain attributes that pertain to the owner of the blockchain address is based on a presentation of a form of identification by the owner of the blockchain address to the identification service.

4. The computer-implemented method of claim 2, wherein verifying that the owner of the blockchain address owns the blockchain address comprises: receiving a message that has been signed using a private key that is under the control of the owner of the blockchain address; and determining that the private key corresponds to the blockchain address by decrypting the signed message with a public key of the blockchain address.

5. The computer-implemented method of claim 2, wherein verifying that the owner of the blockchain address owns the blockchain address comprises: witnessing, by the identification service, that a transaction has been signed by the owner of the blockchain address using a private key that corresponds to the blockchain address; and witnessing, by the identification service, that the transaction blockchain that includes the blockchain address has confirmed the transaction.

6. The computer-implemented method of claim 5, wherein the transaction is signed using a cryptocurrency wallet of the owner of the blockchain address.

7. The computer-implemented method of claim 5, wherein witnessing that the transaction blockchain that includes the blockchain address has confirmed the transaction comprises monitoring a blockchain explorer of the transaction blockchain.

8. The computer-implemented method of claim 1, wherein receiving the attribute query and providing the attribute response is performed using a cross-chain messaging protocol of the identification service.

9. The computer-implemented method of claim 8, wherein the cross-chain messaging protocol comprises: providing, to the transaction blockchain, a public key of the identification service; and signing, by one or more nodes of the identification service blockchain, the attribute response, such that the transaction blockchain is enabled to cryptographically prove that the attribute response is from the identification service using the public key of the identification service.

10. The computer-implemented method of claim 1, further comprising: publishing, by the identification service, a set of enumerated attributes that are available for querying; and wherein the attribute query received from the transaction blockchain includes a request for confirmation of whether an attribute value of the owner of the blockchain address corresponds to an enumerated attribute value represented in the attribute query.

11. The computer-implemented method of claim 10, wherein the attribute response is a binary value that indicates whether the attribute value of the owner of the blockchain address corresponds to the enumerated attribute value represented in the attribute query.

12. The computer-implemented method of claim 1, further comprising: logging, by the identification service, data that represents a received attribute query and a corresponding attribute response; receiving, by the identification service and from a requestor device, a request for attribute query/response log data; and in response to receiving the request for attribute query/response log data, (i) retrieving, from the identification service blockchain, query/response log data that corresponds to the request, and (ii) providing to the retrieved query/response log data to the requestor device.

13. The computer-implemented method of claim 1, further comprising: receiving, by the identification service, a report of a compromised private key that corresponds to the blockchain address; verifying an off-chain identity of the owner of the blockchain address; and submitting an update to the identification service blockchain that removes the relational link between (i) the blockchain address and (ii) the plurality of off-chain attributes that pertain to the owner of the blockchain address.

14. A computer system for performing authentication of blockchain addresses, comprising:
one or more data processing apparatuses of an identification service, the one or more data processing apparatuses comprising one or more processors, memory, and storage devices storing instructions that, when executed, cause the one or more processors to perform operations comprising:
storing, by an identification service blockchain of the identification service, a relational link between (i) a blockchain address and (ii) a plurality of off-chain attributes that pertain to an owner of the blockchain address;
receiving, by the identification service and from a transaction blockchain that includes the blockchain address, an attribute query for attribute data corresponding to at least some of the plurality of off-chain attributes that pertain to the owner of the blockchain address;
in response to receiving the attribute query, retrieving, from the identification service blockchain, the attribute data corresponding to at least some of the plurality of off-chain attributes; and
providing, by the identification service and to the transaction blockchain that includes the blockchain address, an attribute response that includes the attribute data corresponding to at least some of the plurality of off-chain attributes.

15. The computer system of claim 14, the operations further comprising: verifying an off-chain identity of the owner of the blockchain address; verifying the plurality of off-chain attributes that pertain to the owner of the blockchain address; and verifying that the owner of the blockchain address owns the blockchain address.

16. The computer system of claim 14, wherein receiving the attribute query and providing the attribute response is performed using a cross-chain messaging protocol of the identification service.

17. The computer system of claim 14, the operations further comprising: publishing, by the identification service, a set of enumerated attributes that are available for querying; and wherein the attribute query received from the transaction blockchain includes a request for confirmation of whether an attribute value of the owner of the blockchain address corresponds to an enumerated attribute value represented in the attribute query.

18. The computer system of claim 14, the operations further comprising: logging, by the identification service, data that represents a received attribute query and a corresponding attribute response; receiving, by the identification service and from a requestor device, a request for attribute query/response log data; and in response to receiving the request for attribute query/response log data, (i) retrieving, from the identification service blockchain, query/response log data that corresponds to the request, and (ii) providing to the retrieved query/response log data to the requestor device.

19. The computer system of claim 14, the operations further comprising: receiving, by the identification service, a report of a compromised private key that corresponds to the blockchain address; verifying an off-chain identity of the owner of the blockchain address; and submitting an update to the identification service blockchain that removes the relational link between (i) the blockchain address and (ii) the plurality of off-chain attributes that pertain to the owner of the blockchain address.
